(19) United States
(12) Patent Application Publication
(10) Pub. No.: US 2026/0073132 A1
(43) Pub. Date: Mar. 12, 2026

(54) SYSTEMS AND METHODS FOR DETECTING HUMAN-GENERATED TEXT AND MACHINE-GENERATED TEXT IN MIXED TEXT

(71) Applicant: JPMORGAN CHASE BANK, N.A., New York, NY (US)

(72) Inventors: Eric LEI, New York, NY (US); Hsiang HSU, Boston, MA (US); Richard CHEN, Baldwin Place, NY (US)

(21) Appl. No.: 18/830,551

(22) Filed: Sep. 10, 2024

(51) Int. Cl. G06F 40/20; G06N 7/01

(52) U.S. Cl. CPC G06F 40/20; G06N 7/01

(57) ABSTRACT

Systems and methods for detecting human-generated text and machine-generated text in mixed text are disclosed. A computer program receives a dataset of human-generated text and generates a synthetic mixed text dataset by randomly replacing portions of the human-generated text with machine-generated text. The program evaluates the synthetic mixed text dataset at multiple levels, each representing a different fraction of machine-generated text, and computes a first text discriminator score for each level. Upon receiving a text sample, the program computes a second text discriminator score, fits a kernel density estimate using a Gaussian kernel to model a conditional probability distribution, samples from a posterior distribution, and returns an interval representing the amount of machine-generated text in the sample. The program can also split the text sample into segments, define concatenated subsequences, identify indices that maximize an objective function, and return identified machine-generated segments to a user electronic device.

### BACKGROUND OF THE INVENTION

### 1. Field of the Invention

Embodiments relate to systems and methods for detecting human-generated text and machine-generated text in mixed text.

### 2. Description of the Related Art

Following the development and wide-spread deployment of Large Language Models (LLMs), the use of LLM-generated text is becoming increasingly popular across all aspects of society. LLM-generated text is becoming more and more human-like, and it can be difficult to detect LLM-generated text with the naked eye. To make detection of LLM-generated text even more difficult, after LLM-generate text is often edited by humans. This introduces challenges, such as fairly assessing student work, identifying false information, detecting copyright infringement, among others.

### SUMMARY OF THE INVENTION

Systems and methods for detecting human-generated text and machine-generated text in mixed text are disclosed. In one embodiment, a method may include: receiving, by a computer program executed by an electronic device, a dataset of human-generated text; generating, by the computer program, a synthetic mixed text dataset by randomly replacing portions of the human-generated text with machine-generated text; evaluating, by the computer program, the synthetic mixed text dataset at a plurality of levels, each level representing a different fraction of machine-generated text; computing, by the computer program, a first text discriminator score for each level using a function; receiving, by the computer program, a text sample; computing, by the computer program, a second text discriminator score for the text sample; fitting, by the computer program, a kernel density estimate for the second text discriminator score using a Gaussian kernel to model a conditional probability distribution; sampling, by the computer program, from a posterior distribution of the conditional probability distribution; and returning, by the computer program, an interval comprising a fraction of posterior samples that represents an amount of machine-generated text in the sample.

In one embodiment, the step of generating the synthetic mixed text dataset further comprises: randomly masking, by the computer program, a portion of the human-generated text; prompting, by the computer program, a large language model to provide the machine-generated text for the masked portion; and replacing, by the computer program, the masked portion of the human-generated text with the machine-generated text.

In one embodiment, the portion comprises a sentence.

In one embodiment, the first text discriminator score or the second text discriminator score comprises a log-likelihood drop value, a logit score from a ROBERTa model, and a classifier with LogitNorm regularization.

In one embodiment, the posterior distribution of the conditional probability distribution is sampled using the Metropolis-Hastings algorithm.

In one embodiment, the step of evaluating the synthetic mixed text dataset at a plurality of levels comprises: selecting, by the computer program, a fraction of the synthetic mixed text dataset to evaluate, with each level being a different fraction based on a number of characters in the synthetic mixed text dataset.

In one embodiment, the fraction of posterior samples is based on a confidence level.

In one embodiment, the method may also include: splitting, by the computer program, the text sample into a plurality of segments; defining, by the computer program, a plurality of concatenated subsequences of the plurality of segments; identifying, by the computer program, a set of indices that maximizes an objective function; iteratively adding, by the computer program, indices that maximize a marginal gain of the objective function; and returning, by the computer program, identified machine-generated segments to a user electronic device. The step of splitting the text sample into segments may include splitting, by the computer program, the text sample into one of words, sentences, and paragraphs. The step of iteratively adding indices that maximize the marginal gain of the objective function may include: initializing, by the computer program, an empty set of indices and at each iteration; and adding, by the computer program, an index that maximizes the marginal gain until there is no additional positive marginal gain.

According to another embodiment, a non-transitory computer readable storage medium, including instructions stored thereon, which when read and executed by one or more computer processors, cause the one or more computer processors to perform steps comprising: receiving a dataset of human-generated text; generating a synthetic mixed text dataset by randomly replacing portions of the human-generated text with machine-generated text; evaluating the synthetic mixed text dataset at a plurality of levels, each level representing a different fraction of machine-generated text; computing a first text discriminator score for each level using a function; receiving a text sample; computing a second text discriminator score for the text sample; fitting a kernel density estimate for the second text discriminator score using a Gaussian kernel to model a conditional probability distribution; sampling, from a posterior distribution of the conditional probability distribution; and returning an interval comprising a fraction of posterior samples that represents an amount of machine-generated text in the sample.

In one embodiment, the non-transitory computer readable storage medium may also include instructions stored thereon, which when read and executed by the one or more computer processors, cause the one or more computer processors to generate the synthetic mixed text dataset includes by performing steps comprising: randomly masking a portion of the human-generated text; prompting a large language model to provide the machine-generated text for the masked portion; and replacing the masked portion of the human-generated text with the machine-generated text.

In one embodiment, the portion comprises a sentence.

In one embodiment, the first text discriminator score or the second text discriminator score comprises a log-likelihood drop value, a logit score from a ROBERTa model, and a classifier with LogitNorm regularization.

In one embodiment, the posterior distribution of the conditional probability distribution is sampled using the Metropolis-Hastings algorithm.

In one embodiment, the non-transitory computer readable storage medium may also include instructions stored thereon, which when read and executed by the one or more computer processors, cause the one or more computer processors to evaluate the synthetic mixed text dataset at a plurality of levels by performing steps comprising: selecting a fraction of the synthetic mixed text dataset to evaluate, with each level being a different fraction based on a number of characters in the synthetic mixed text dataset.

In one embodiment, the fraction of posterior samples is based on a confidence level.

In one embodiment, the non-transitory computer readable storage medium may also include instructions stored thereon, which when read and executed by one or more computer processors, cause the one or more computer processors to perform steps comprising: splitting the text sample into a plurality of segments; defining a plurality of concatenated subsequences of the plurality of segments; identifying a set of indices that maximizes an objective function; iteratively adding indices that maximize a marginal gain of the objective function; and returning identified machine-generated segments to a user electronic device.

In one embodiment, the non-transitory computer readable storage medium may also include instructions stored thereon, which when read and executed by the one or more computer processors, cause the one or more computer processors to split the text sample into segments by performing steps comprising: splitting the text sample into one of words, sentences, and paragraphs.

In one embodiment, the non-transitory computer readable storage medium may also include instructions stored thereon, which when read and executed by the one or more computer processors, cause the one or more computer processors to iteratively add indices that maximize the marginal gain of the objective function by performing steps comprising: initializing an empty set of indices and at each iteration; and adding an index that maximizes the marginal gain until there is no additional positive marginal gain.

### BRIEF DESCRIPTION OF THE DRAWINGS

For a more complete understanding of the present invention, the objects and advantages thereof, reference is now made to the following descriptions taken in connection with the accompanying drawings in which:

FIG. 1A illustrates a curve of a property of human text and a curve of the property of machine-generated text according to an embodiment;

FIG. 1B illustrates a curve of a property of human text, a curve of the property of machine-generated text, and a curve of the property of mixed text according to an embodiment;

FIG. 2 illustrates a system for detecting human-generated text and machine-generated text in mixed text according to an embodiment;

FIG. 3 illustrates a method for detecting human-generated text and machine-generated text in mixed text according to an embodiment;

FIG. 4 depicts a method for identifying machine-generated text in mixed text according to an embodiment; and

FIG. 5 depicts an exemplary computing system for implementing aspects of the present disclosure.

### DETAILED DESCRIPTION OF PREFERRED EMBODIMENTS

Embodiments relate to systems and methods for detecting human and machine-generated mixed text. For example, embodiments may evaluate text that may include both machine-generated (e.g., LLM-generated) text and human-generated text.

Embodiments may use incremental perturbation of texts by language models to measure a shift in distribution of the texts by a proposed metric. If the metric is larger than a threshold, the text is more likely to be generated from machines rather than human.

Unlike conventional solutions that can only tell if a piece of text is from a machine or from a human, embodiments may identify a percentage of a text that was generated by machine and identify the machine-generated portions for the user.

Embodiments may discriminate between LLM-generated text and human-generated text based on an observed property that differentiates human and LLM-generated text, such as a log-likelihood drop.

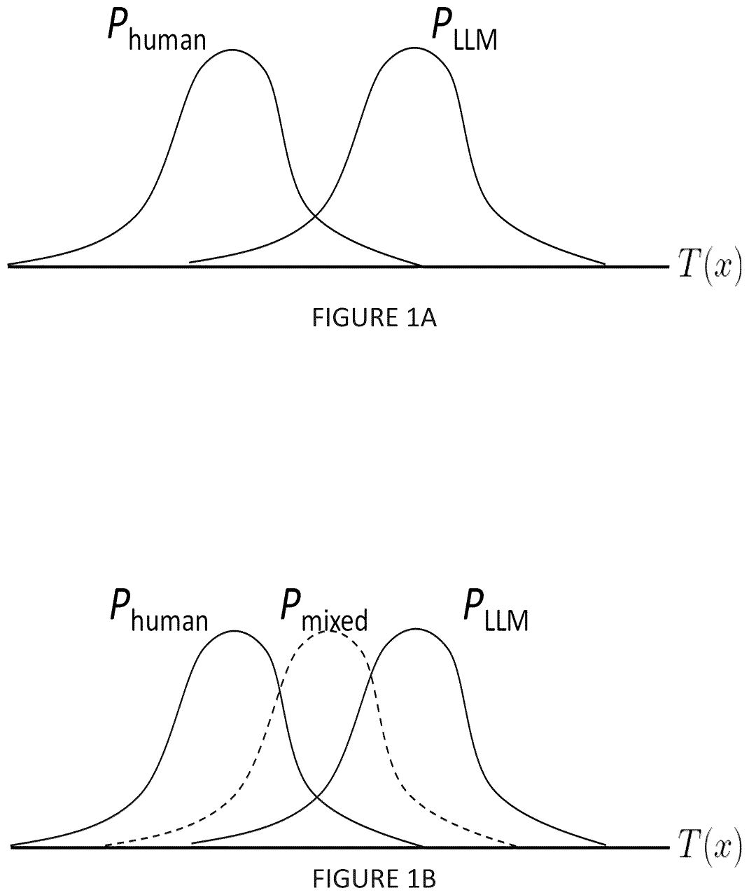

FIG. 1A illustrates a curve of the property of human text (i.e., Pₕᵤₘₐₙ) and a curve of the property of LLM-generated text (i.e., P_{LLM}). Thus, the threshold, T(x) may be used to classify text as human-generated or LLM-generated. A LLM text discriminator score, T, is the output of a function that consumes a piece of text, and outputs a single scalar value. Examples of suitable functions include the log-likelihood drop value from DetectGPT (e.g., Mitchell et al. “DetectGPT: Zero-Shot Machine-Generated Text Detection using Probability Curvature,” Proceedings of the 40th International Conference on Machine Learning, (2023) (available at arxiv.org/abs/2301.11305); logit scores from a ROBERTa (Liu, Y. et al., “ROBERTa: A Robustly Optimized BERT Pretraining Approach,” (2019) available at arXiv:1907.11692 (2019); a classifier with LogitNorm regularization (Wei, Hongxin, et al., “Mitigating neural network overconfidence with logit normalization,” International conference on machine learning,” PMLR, (2022) available at arXiv:2205.09310), trained to binary classify model/human text, etc. The disclosures of each of these documents is hereby incorporated, by reference, in its entirety. Other functions may be used as is necessary and/or desired.

The output of the function represents a score that is generally larger when text is written by a LLM, and smaller when text is written by a human. The different types of scores may vary as they are based on properties of LLMs that discriminate between human and LLM-generated text. For DetectGPT and Fast-DetectGPT, the LLM probability curvature (i.e., a characteristic of the way in which a LLM ranks which words in its vocabulary are most likely to come next) is an example of such.

FIG. 1B illustrates a curve of the property of human text (i.e., Pₕᵤₘₐₙ), a curve of the property of mixed human and machine-generated text (i.e., P_{mixed}) and a curve of the property of LLM-generated text (i.e., P_{LLM}). As illustrated, the property for the mixed text, P_{mixed}, lies between that for the human text and LLM-generated text. The amount of shift between Pₕᵤₘₐₙ and P_{LLM} may indicate the ratio of LLM-generated to human text.

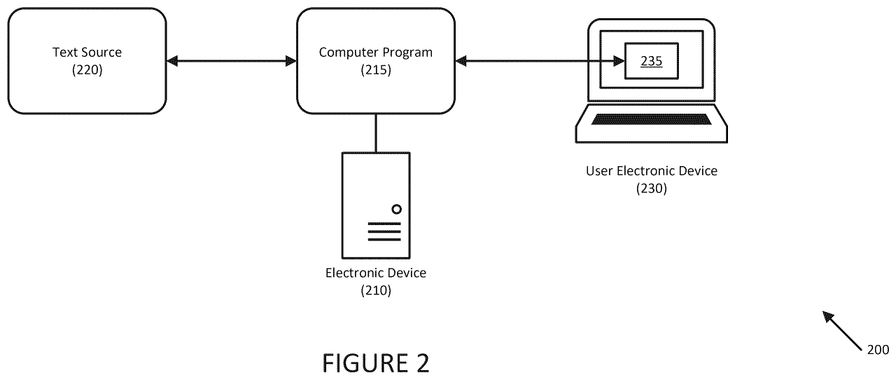

Referring to FIG. 2, a system for detecting human and machine-generated mixed text is disclosed according to an embodiment. System 200 may include electronic device 210, which may be a server (e.g., physical and/or cloud based), a computer (e.g., workstation, desktop, laptop, notebook, tablet, etc.), etc. Electronic device 210 may execute one or more computer programs or applications, including computer program 215.

Computer program 215 may be a computer program that may detect human text and machine-generated mixed text, as described below. Computer program 215 may receive mixed text from text source 220.

System 200 may further include user electronic device 230, which may be a computer (e.g., workstation, desktop, laptop, notebook, tablet, etc.), etc. In one embodiment, electronic device 210 and user electronic device 230 may be the same electronic device.

User electronic device 230 may execute user computer program 235. User computer program 235 may interface with computer program 215 (e.g., user computer program may be a browser, a distributed application, etc.), etc. If user electronic device 230 and electronic device 210 are the same, computer program 215 and user computer program 235 may be the same.

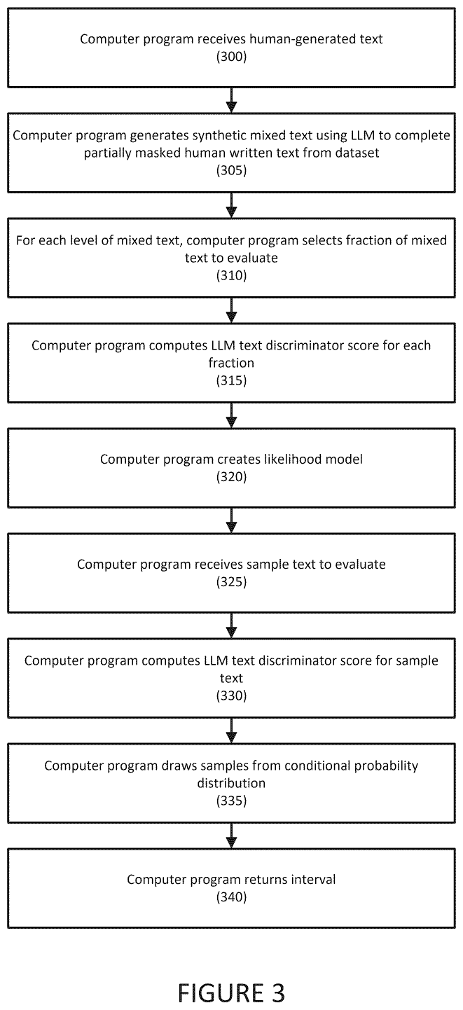

Referring to FIG. 3, a method for detecting human and machine-generated mixed text is disclosed according to an embodiment.

In step 300, a computer program may receive human-generated text. For example, the computer program may receive a dataset including a number of samples of human-generated text. Each sample may include a plurality of sentences that are authored by a human.

In step 305, a computer program may generate a synthetic mixed text dataset that may include the human generated text in which one or more portions have been replaced with machine-generated text. The synthetic mixed text dataset may correspond to the dataset of human text at a plurality of levels, K. Each level may be different.

In one embodiment, given a human generated text, one or more portions of the human generated text (e.g., one or more sentences) may be randomly replaced with a [MASK] symbol. For example, the sample “{sentence 1}. {sentence 2}. {sentence 3}.”, may be masked as “{sentence 1}. [MASK]. {sentence 3}.”, where the second sentence was randomly selected. Each sample in the dataset may be masked once.

Next, the computer program may prompt the LLM to ask what sentences should go in the [MASK] location(s) of the text. An example prompt is: “What sentences should go in the {n_replace} [MASK] locations of the following text? Only provide exactly one sentence per [MASK] location. Only provide the sentences as a numbered list with {n_replace} sentences total”, followed by the masked text. Note that “n_replace” is equal to the number of “[MASK]” symbols used.

The LLM may return one sentence per mask location, resulting in a list of sentences. Each of returned sentences may be included in the synthetic mixed text dataset.

In step 310, the computer program may select a fraction of the synthetic mixed text dataset to evaluate. The text may be evaluated at a plurality of levels, which each level being a different fraction. In one embodiment, the fraction may be based on a number of characters in the synthetic mixed text dataset.

For example, the number of mixed-text levels, K, may be used to set a value for each target level, δ. For example, if the number of mixed-text levels is 9, the target levels, δ, may have values from 0.1, 0.2, 0.3, . . . , 0.9. As another example, if the number of mixed-text levels is 3, the value of the target levels, δ, may be 0.25, 0.50, and 0.75. Any suitable number of levels and values that uniformly sweep from 0.0 to 1.0 may be used as is necessary and/or desired; a greater number of levels increases the length of time for the computer program to run.

For each target level (e.g., 0.2), a fraction of the sentences in the synthetic mixed text dataset may be masked with the [MASK] symbol (e.g., 0.2× the number of sentences are replaced with [MASK]) The number of sentences to replace may be rounded up to the next nearest integer so that the number of masks is at least one and at most the number of sentences in the original text.

To determine the fraction at the character level, the number of LLM-written characters in the synthetic mixed text dataset (e.g., the sentence provided by the LLM to replace the [MASK] symbol) may be divided by the total number of characters of the synthetic mixed text dataset (i.e., the total number of characters in the original sentences plus the sentence provided by the LLM. This is done for each filled text. Thus, if there are 9 target levels, the number of synthetic mixed texts is 9 times the original dataset size.

Next, the filled texts are grouped by the fraction of LLM characters to total characters to the target levels δₖ into a plurality of “bins” (e.g., all filled synthetic mixed text datasets with character fraction ranging from 0.15 to 0.24 get classified into the 0.2 bin). This results in synthetic mixed text datasets that are organized by the character level fraction according to the target levels.

In step 315, for each target level, the computer program may compute the LLM text discriminator score, T, using a function (e.g., the log-likelihood drop value from DetectGPT, logit scores from a ROBERTa, a classifier with LogitNorm regularization trained to binary classify model/human text, etc.).

The LLM text discriminator scores of the filled texts in bin δₖ may be said to have distribution T|δₖ.

In step 320, the computer program may create a model for the likelihood probability distribution, P(T|δ). Specifically, P_{mixed} is P(T|δ) for some 0<δ<1, where Pₕᵤₘₐₙ is when δ=0, and P_{LLM} is when the target level δ=1.

The computer program may fit a kernel density estimation (KDE) (e.g., a process for finding an estimate probability density function of a random variable), fₖ(T), for each of the text discriminator score T|δₖ, k∈1, . . . , K distributions using a Gaussian kernel. For example, the computer program has samples from T|δₖ, where δ₁=0.1, . . . , δ₉=0.9 (i.e., the target levels in the example above). To estimate the probability distribution P(T|δ) for any LLM text discriminator score and target level not contained in the samples, the computer program uses the KDE with a Gaussian kernel as the model for each T|8ₖ distribution to fit a probability distribution to these samples.

For a general target level δ∈[0,1] (not necessarily the δ₁< . . . <δ_{K} values), the computer program may return the probability distribution P(T|δ)=αf_{k*}(T)+(1−α)f_{k*+1}(T), where k* is the index such that δ_{k*}≤δ<δ_{k*+1}, and

$$α = \frac{{δ}_{{k}^{*} + 1} - δ}{{δ}_{{k}^{*} + 1} - {δ}_{{k}^{*}}} .$$

The δₖ values refer to the fixed target levels of δ₁=0.1, . . . , δ₉=0.9. To compute the probability distribution P(T|δ) when δ is equal to one of the target levels (i.e., some δₖ), the value fₖ(T), which is one of the K=9 KDEs, may be returned. However, to compute the probability distribution P(T|δ) when δ is not one of the target levels, the computer program may interpolate the two KDEs corresponding to target levels δₖ that are closest to δ using the equation above. Note that the interpolation formula is consistent, i.e., if δ is equal to one of the target levels, the formula collapses to the KDE of that target level.

The computer program may then return the mixture of the two KDEs with the target levels δₖ that are closest to δ, weighted proportionally by distance to the target levels δₖ. The mixture is a linear combination of the two KDEs corresponding to target levels δₖ that are closest to δ. If the target level δ is closer to one of the two neighboring target levels, then the weighting of linear combination reflects that by putting more weight on the closer KDE. This mixture represents the probability distribution P(T|δ).

In step 325, the computer program may receive a text sample x to evaluate, and in step 330, the computer program may calculate a LLM text discriminator score for the text sample. This may be computed using a function (e.g., the log-likelihood drop value from DetectGPT, logit scores from a ROBERTa, a classifier with LogitNorm regularization trained to binary classify model/human text, etc.

In step 335, the computer program may draw samples from a conditional probability distribution P(δ|T(x))∝P(T(x)|δ)P(δ) that is a posterior distribution of P(T|δ) to sample from P(δ|T=t), where t=T(x) is the computed LLM text discriminator score of a text sample x. The computer program may use the Metropolis-Hasting algorithm, described in Gelman, A., Carlin, J. B., Stern, H. S., Dunson, D. B., Vehtari, A., & Rubin, D. B., “Bayesian Data Analysis” (3rd ed.) (2013), the disclosure of which is hereby incorporated, by reference, in its entirety. The posterior distribution is a kind of conditional probability distribution. In the language of estimation theory, it is referred to as posterior to provide an operational meaning for this conditional probability distribution. It describes the distribution of \delta “post” observing the data, T.

Specifically, the conditional probability distribution P(δ|T) may be defined by the likelihood of a prior distribution, which may be selected from a target level δ∈[0,1]. The prior distribution is assumed to be a known probability distribution. Since 0<δ<1, the Beta (2, 2) distribution is chosen since it is supported for real numbers between 0 and 1. A prior probability distribution P(δ)=Beta(2, 2). The Beta distribution is described in Johnson, Norman L.; Kotz, Samuel; Balakrishnan, N., “Chapter 25: Beta Distributions,” Continuous Univariate Distributions Vol. 2 (2nd ed.)(1995), the disclosure of which is hereby incorporated, by reference, in its entirety.

The computer program may run a Markov chain Monte Carlo method, such as the Metropolis-Hastings algorithm, for a number of iterations, and may discard a fraction of those iterations. The Metropolis-Hastings algorithm is described in Hastings, W. K., “Monte Carlo Sampling Methods Using Markov Chains and Their Applications,” Biometrika. 57 (1): 97-109 (1970), the disclosure of which is hereby incorporated, by reference, in its entirety. For example, for text sample x, and its LLM text discriminator score, the computer program may sample from the conditional probability distribution P(δ|T) using the Metropolis-Hastings algorithm.

The distribution used in the Metropolis-Hasting algorithm may be a truncated normal distribution centered at a previously generated sample, truncated to [0, 1]. The Metropolis-Hastings algorithm is an iterative algorithm that generates a sequence of samples (up to 1 per iteration). The proposal distribution controls how the next sample will be generated, which depends on the previous sample.

In one embodiment, a certain number of iterations may be run, of which a certain amount may be discarded. The number of iterations and number of discarded iterations may be selected as is necessary and/or desired.

The Metropolis-Hasting algorithm generates a sequence of samples that converge to the conditional probability distribution. Thus, the proposal distribution of Metropolis-Hastings is chosen to generate sample n, with a distribution that is dependent on sample n−1.

In step 340, the computer program may return values (L, R) such that it contains 1−α fraction of posterior samples, and among, all such intervals, (L, R) has the smallest width L−R. Values L and R provide the user with an interval that they can be confident the true percentage of model text lies in. If the values L and R are close together, there is high confidence on the value. If the values L and R are far apart, it is difficult to tell the true percentage of model text. For example, if the true machine-generated text percentage, δ*, of the sample text is 0.25, L may be 0.15 and R may be 0.35 as an interval that δ* falls within.

For example, for the LLM text discriminator score for the text sample, T, there is the posterior distribution P(δ|T). The computer program may select the value of δ that has the highest probability, i.e., max_{δ}P(δ|T). However, the estimated δ may not be the same as the underlying true value δ*, as it is unknown. Thus, the interval [L, R] is determined by P(δ|T) with a hope that the interval may include the true unknown value δ* with high confidence.

If L is less than R, and the interval (L, R) is the smallest interval containing 1−α of the posterior probability (intuitively, there is 1−α probability that (L, R) contains the true fraction of model text according to the model).

The computer program may return the L and R values, which give an interval that should contain the percentage of LLM generated text in the sample text. The confidence level, α, may be set by the user. The smaller the value for α, the higher the confidence that δ* is contained in (L, R). Thus, if α is set close to 1, then L and R will become very similar (and this could be considered as an estimate of the percentage). The width of (L, R), i.e., R−L, is more so the precision or error of the interval. As a get smaller (higher confidence), it is natural to expect that the error R-L gets larger.

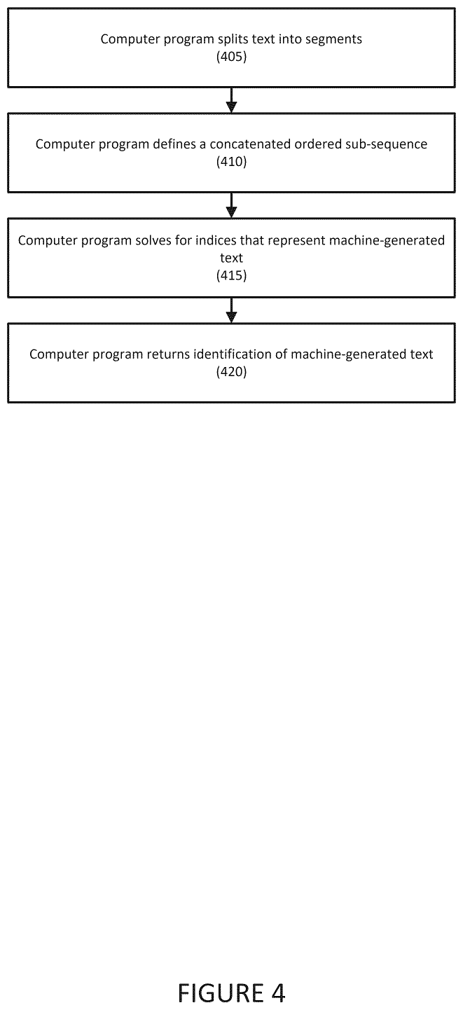

Referring to FIG. 4, a method for identifying machine-generated text in mixed text is disclosed according to an embodiment.

In step 405, upon receiving a mixed text x, a computer program may split the mixed text into a number, n, of segments x₁x₂ . . . xₙ, under some pre-defined scheme. For example, the computer program may split the text into words, sentences, paragraphs, etc.

In step 410, the computer program may define x[I] to be the concatenated ordered sub-sequence indexed by I⊆{{1, . . . , n}. For example, if I={1, 2, 4}, then x[I]=x₁x₂x₄. In one embodiment, each/has equivalent n-length binary representation b₁b₂ . . . bₙ, where bᵢ ∈{0,1} indicates if i is included in I. In the above example, the equivalent binary representation with n=4 is b₁b₂b₃b₄=1101. In one embodiment, all combinations of segments may be selected.

All possible I may be considered except when no segments are elected (i.e., I=Ø) or when all segments are selected (i. e., I^{C}=Ø), corresponding to all 0's or all 1's in binary, for a total of 2ⁿ−2 subsequences. If all subsets of/are enumerated, they would look like I={1}, I={1,2}, I={2}, I={3}, I={1,3}, I={2,3}, 1={1,2,3}, I={4}, . . . , I={1,2,3, . . . ,n}.

In step 415, the computer program may find the set of indices/that maximizes an objective function, such as I*=argmax_{I⊆{1 . . . ,n}}T(x[I])−T(x[I^{C}]). In one embodiment, the computer program may iterate over all possible subsets of I in order to find the optimal subset. For example, if there are 3 sentences, then I⊆{{1, 2, 3}. If I is selected to equal {1, 2}, then I^{C} represents the sentences not selected, i.e., I^{C}={3}. The optimal subset is the set I corresponding to exactly choosing the sentences that were machine-generated. If n is small enough (e.g., less than or equal to 10), the optimal subset may be chosen by brute force, for example, by enumerating all possible subsets I, and evaluating the objective function for each possible subset. For example, the optimal subset is the one that yields the largest value.

For a larger n, the computer program may solve the objective function using, a Greedy algorithm, by iteratively adding indices that maximize marginal gain of T(x[I])−T(x[I^{C}]). The Greedy algorithm may initialize I=Ø. At each iteration, it will consider all the segments (e.g., sentences) of the sample text, e∈{1, . . . , n}\ I, i.e., all the indices that have not been chosen yet (placed in I). The Greedy algorithm will select the element e (e.g., a sentence) that maximizes marginal gain T(x[I∪e])−T(x[(I∪e)^{C}])−(T(x[I])−T(x[I^{C}])) and then places e into I:I←I∪e. It will repeat this until there are no more elements that result in positive marginal gain.

In step 420, the computer program may return I* as segment of indices predicted to be model generated. In one embodiment, the computer program may identify the sentences corresponding to the indices and may return the identification of, or the actual sentences, that are predicted to be machine-generated.

For example, if I is 0100, this indicates that the second sentence is machine-generated.

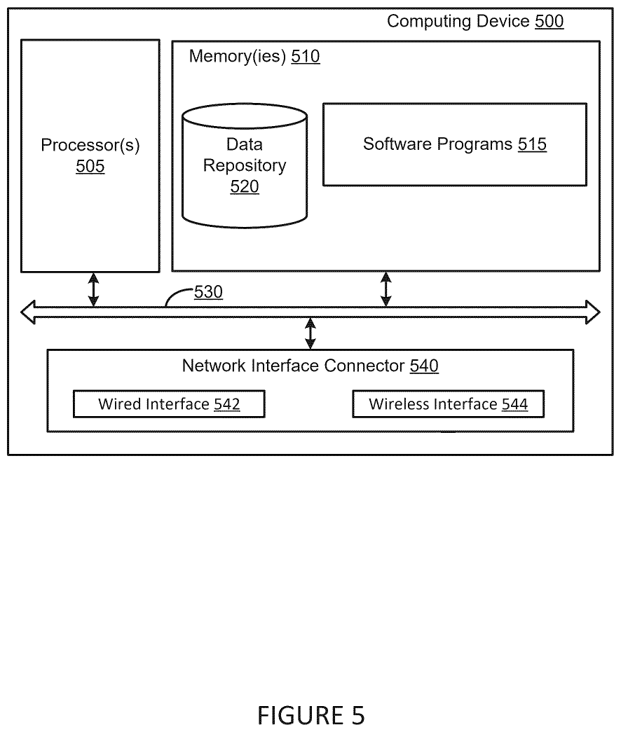

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed by an electronic device, a dataset of human-generated text;
generating, by the computer program, a synthetic mixed text dataset by randomly replacing portions of the human-generated text with machine-generated text;
evaluating, by the computer program, the synthetic mixed text dataset at a plurality of levels, each level representing a different fraction of machine-generated text;
computing, by the computer program, a first text discriminator score for each level using a function;
receiving, by the computer program, a text sample;
computing, by the computer program, a second text discriminator score for the text sample;
fitting, by the computer program, a kernel density estimate for the second text discriminator score using a Gaussian kernel to model a conditional probability distribution;
sampling, by the computer program, from a posterior distribution of the conditional probability distribution; and
returning, by the computer program, an interval comprising a fraction of posterior samples that represents an amount of machine-generated text in the sample.

2. The method of claim 1, wherein the step of generating the synthetic mixed text dataset further comprises:
randomly masking, by the computer program, a portion of the human-generated text;
prompting, by the computer program, a large language model to provide the machine-generated text for the masked portion; and
replacing, by the computer program, the masked portion of the human-generated text with the machine-generated text.

3. The method of claim 2, wherein the portion comprises a sentence.

4. The method of claim 1, wherein the first text discriminator score or the second text discriminator score comprises a log-likelihood drop value, a logit score from a ROBERTa model, and a classifier with LogitNorm regularization.

5. The method of claim 1, wherein the posterior distribution of the conditional probability distribution is sampled using the Metropolis-Hastings algorithm.

6. The method of claim 1, wherein the step of evaluating the synthetic mixed text dataset at a plurality of levels comprises:
selecting, by the computer program, a fraction of the synthetic mixed text dataset to evaluate, with each level being a different fraction based on a number of characters in the synthetic mixed text dataset.

7. The method of claim 1, wherein the fraction of posterior samples is based on a confidence level.

8. The method of claim 1, further comprising:
splitting, by the computer program, the text sample into a plurality of segments;
defining, by the computer program, a plurality of concatenated subsequences of the plurality of segments;
identifying, by the computer program, a set of indices that maximizes an objective function;
iteratively adding, by the computer program, indices that maximize a marginal gain of the objective function; and
returning, by the computer program, identified machine-generated segments to a user electronic device.

9. The method of claim 8, wherein the step of splitting the text sample into segments comprises:
splitting, by the computer program, the text sample into one of words, sentences, and paragraphs.

10. The method of claim 8, wherein the step of iteratively adding indices that maximize the marginal gain of the objective function comprises:
initializing, by the computer program, an empty set of indices and at each iteration; and
adding, by the computer program, an index that maximizes the marginal gain until there is no additional positive marginal gain.

11. A non-transitory computer readable storage medium, including instructions stored thereon, which when read and executed by one or more computer processors, cause the one or more computer processors to perform steps comprising:
receiving a dataset of human-generated text;
generating a synthetic mixed text dataset by randomly replacing portions of the human-generated text with machine-generated text;
evaluating the synthetic mixed text dataset at a plurality of levels, each level representing a different fraction of machine-generated text;
computing a first text discriminator score for each level using a function;
receiving a text sample;
computing a second text discriminator score for the text sample;
fitting a kernel density estimate for the second text discriminator score using a Gaussian kernel to model a conditional probability distribution;
sampling, from a posterior distribution of the conditional probability distribution; and
returning an interval comprising a fraction of posterior samples that represents an amount of machine-generated text in the sample.

12. The non-transitory computer readable storage medium of claim 11, further including instructions stored thereon, which when read and executed by the one or more computer processors, cause the one or more computer processors to generate the synthetic mixed text dataset includes by performing steps comprising:
randomly masking a portion of the human-generated text;
prompting a large language model to provide the machine-generated text for the masked portion; and
replacing the masked portion of the human-generated text with the machine-generated text.

13. The non-transitory computer readable storage medium of claim 12, wherein the portion comprises a sentence.

14. The non-transitory computer readable storage medium of claim 11, wherein the first text discriminator score or the second text discriminator score comprises a log-likelihood drop value, a logit score from a ROBERTa model, and a classifier with LogitNorm regularization.

15. The non-transitory computer readable storage medium of claim 11, wherein the posterior distribution of the conditional probability distribution is sampled using the Metropolis-Hastings algorithm.

16. The non-transitory computer readable storage medium of claim 11, further including instructions stored thereon, which when read and executed by the one or more computer processors, cause the one or more computer processors to evaluate the synthetic mixed text dataset at a plurality of levels by performing steps comprising:
selecting a fraction of the synthetic mixed text dataset to evaluate, with each level being a different fraction based on a number of characters in the synthetic mixed text dataset.

17. The non-transitory computer readable storage medium of claim 11, wherein the fraction of posterior samples is based on a confidence level.

18. The non-transitory computer readable storage medium of claim 11, further including instructions stored thereon, which when read and executed by one or more computer processors, cause the one or more computer processors to perform steps comprising:
splitting the text sample into a plurality of segments;
defining a plurality of concatenated subsequences of the plurality of segments;
identifying a set of indices that maximizes an objective function;
iteratively adding indices that maximize a marginal gain of the objective function; and
returning identified machine-generated segments to a user electronic device.

19. The non-transitory computer readable storage medium of claim 18, further including instructions stored thereon, which when read and executed by the one or more computer processors, cause the one or more computer processors to split the text sample into segments by performing steps comprising:
splitting the text sample into one of words, sentences, and paragraphs.

20. The non-transitory computer readable storage medium of claim 19, further including instructions stored thereon, which when read and executed by the one or more computer processors, cause the one or more computer processors to iteratively add indices that maximize the marginal gain of the objective function by performing steps comprising:
initializing an empty set of indices and at each iteration; and
adding an index that maximizes the marginal gain until there is no additional positive marginal gain.
